(19) United States
(12) Patent Application Publication
(10) Pub. No.: US 2018/0274682 A1
(43) Pub. Date: Sep. 27, 2018

(54) SEALING DEVICE

(71) Applicant: JTEKT CORPORATION, Osaka (JP)

(72) Inventor: Yohei SHIMIZU, Kashiwara-shi (JP)

(73) Assignee: JTEKT CORPORATION, Osaka (JP)

(21) Appl. No.: 15/919,802

(22) Filed: Mar. 13, 2018

(30) Foreign Application Priority Data
Mar. 21, 2017 (JP) 2017-054627
Mar. 21, 2017 (JP) 2017-054866

(51) Int. Cl. F16J 15/3296; F16J 15/3204

(52) U.S. Cl. CPC F16J 15/3296; F16J 15/3204

(57) ABSTRACT

A sealing device includes a conductive member integrated with a seal lip along a circumferential direction of the seal lip and configured such that a voltage is applied to the conductive member, and a reference member provided at a predetermined interval with respect to the conductive member. A deformation degree of the seal lip is inspected such that a change of an inductance of the conductive member associated with a change of the interval between the conductive member and the reference member is detected by a detection unit.

### INCORPORATION BY REFERENCE

The disclosure of Japanese Patent Application No. 2017-054627 filed on Mar. 21, 2017 and Japanese Patent Application No. 2017-054866 filed on Mar. 21, 2017, each including the specification, drawings and abstract, is incorporated herein by reference in its entirety.

### BACKGROUND

### 1. Technical Field

The disclosure relates to a sealing device.

### 2. Description of Related Art

A sealing device is used for a rotational member in an industrial product or an industrial machine, in order to prevent an invasion of a foreign matter into a space between a rotating shaft and a housing and an outflow of a lubricant such as grease. An example of the sealing device is a sealing device including a seal lip that slidably makes close contact with a rotating shaft. An oil seal has been widely used as such a sealing device.

### SUMMARY

When a sealing surface on an inner periphery of the seal lip makes close contact with an abutting surface of a rotating shaft, the sealing surface slides with respect to the rotating shaft. The sealing surface is gradually worn out by friction. The seal lip gradually deforms in the direction approaching the rotating shaft along with the wearing-out. When the seal lip deforms by a predetermined amount due to the wearing-out of the sealing surface, a contact pressure between the sealing surface and the rotating shaft becomes insufficient, so that seal performance is decreased, thereby causing an invasion of a foreign matter into an annular space or an outflow of a lubricant to outside the annular space.

Generally, this problem can be solved by replacing the sealing device regularly. That is, the replacement of the sealing device is performed at an interval shorter than a period during which the seal performance is decreased, so as to prevent the invasion of a foreign matter into the rotational member and the outflow of the lubricant. However, in such a method, a replacement cycle of the sealing device is short, so that it takes time to perform maintenance of the sealing device. Further, if an abnormal deformation occurs in the seal lip before a predetermined replacement timing comes, it is difficult to restrain the invasion of a foreign matter into the annular space and the outflow of the lubricant to outside the annular space.

In view of this, it is conceivable to inspect a deformation degree of the seal lip, i.e., whether or not the deformation reaches a predetermined amount, by using an inspection apparatus disclosed in Japanese Unexamined Patent Application Publication No. 2014-74469 (JP 2014-74469 A). The inspection apparatus disclosed in JP 2014-74469 A is configured to detect whether or not a garter spring is attached to a prescribed position of a seal lip of an oil seal by fitting the oil seal to the inspection apparatus. When the seal lip deforms, a position at which the garter spring is attached also changes. Accordingly, it is presumably possible to inspect whether or not the seal lip has deformed at the predetermined amount, by detecting whether or not the position at which the garter spring is attached changes from a predetermined position by the predetermined amount, by using the inspection apparatus disclosed in JP 2014-74469 A.

However, in a case where the inspection is performed by using the inspection apparatus disclosed in JP 2014-74469 A, it is necessary to stop an operation of the rotational member and remove the oil seal, and to fit the oil seal to the inspection apparatus. This accordingly decreases operation efficiency of the rotational member.

The present disclosure is accomplished in view of such a problem, and an object of the present disclosure is to provide a sealing device including a seal lip having a sealing surface making close contact with a rotating shaft of a rotational member, the sealing device being able to inspect a deformation degree of a seal lip, caused due to wearing-out of the sealing surface without decreasing operation efficiency of the rotational member.

An aspect of the present disclosure is related to a sealing device provided radially inward of an inner peripheral surface of an outer member. The sealing device includes an attachment portion having an annular shape and attached to the outer member, a seal lip having an annular shape and being fixed to the attachment portion and having a sealing surface in an inner peripheral part of the seal lip, the sealing surface making contact with a shaft provided radially inward of the inner peripheral surface of the outer member. The sealing device also includes a conductive member integrated with the seal lip along a circumferential direction of the seal lip, the conductive member being configured such that a voltage is applied to the conductive member. The sealing device also includes a reference member placed so that a predetermined interval is provided between the conductive member and the reference member. The sealing device also includes a detection unit. The detection unit detects a change of an inductance of the conductive member associated with a change of the interval between the conductive member and the reference member.

In the above aspect of the present disclosure, the reference member may be a member having conductivity and provided in the seal lip or the attachment portion in a state where the member is distanced from the conductive member at the predetermined interval.

With the sealing device, when the seal lip deforms associated with wearing-out of the sealing surface, the interval between the conductive member and the reference member (the member having conductivity) changes. Further, the conductive member functions as a magnetic sensor when a voltage is applied to the conductive member. Because of this, the change of the interval between the conductive member and the reference member as a sensing target is detected as a change of the inductance of the conductive member. Hereby, it is possible to inspect a deformation degree of the seal lip by an easy configuration. Further, the deformation degree of the seal lip can be inspected even while a rotational member to which the sealing device is attached is rotating. Hereby, the deformation degree of the seal lip can be inspected without reducing operation efficiency.

The conductive member may be provided annularly along the circumferential direction of the seal lip so as to be concentric to the seal lip. The reference member may be provided annularly along the circumferential direction of the seal lip so as to be concentric to the seal lip.

With the sealing device, the deformation of the seal lip is sensed over its entire circumference. As a result, it is possible to improve inspection accuracy of the deformation degree of the seal lip.

The conductive member and the reference member may be annular metal wires placed in the seal lip. A diameter of section of each of the annular metal wires may be equal to or smaller than a predetermined diameter.

In a case where the conductive member and the reference member are bold metal wires, deformation of the seal lip is disturbed by their rigidities. As a result, the deformation degree of the seal lip cannot be inspected accurately. In contrast, when the metal wire having a section with a diameter that is the predetermined diameter or less is used as the conductive member and the reference member, a possibility to disturb the deformation of the seal lip associated with wearing-out of the sealing surface is low because the rigidity of the metal wire is low. This makes it is possible to inspect the deformation degree of the seal lip with high accuracy.

The reference member may be a core member provided in the attachment portion. The reference member may be an annular spring configured to tighten an inner periphery of the seal lip to the shaft.

When the member having conductivity and constituting the sealing device doubles as the reference member, the number of components to be placed in the sealing device can be restrained. This makes it possible to easily manufacture the sealing device.

The core member may have an L-shaped section with one side facing the seal lip. The detection unit may be placed on an inner surface of the core member.

When the detection unit is provided by effectively using a space in the sealing device as such, it is possible to restrain upsizing of the sealing device.

A voltage may be applied to the reference member.

With the sealing device, a magnetic field is also generated around the reference member, thereby making it possible to increase its influence on the magnetic field around the conductive member. That is, it is possible to largely change magnetic resistance around the conductive member at the time when the interval between the conductive member and the reference member changes. As a result, the deformation degree of the seal lip can be inspected more accurately.

In the foregoing aspect of the present disclosure, the reference member may be the shaft.

With the sealing device having such a structure, when the seal lip deforms along with wearing-out of the sealing surface, an interval between the conductive member and the reference member (a shaft) changes. Further, the conductive member functions as a magnetic sensor when a voltage is applied to the conductive member. Because of this, a change of the interval between the conductive member and the reference member as a sensing target is detected as a change of the inductance of the conductive member. Hereby, it is possible to inspect the deformation degree of the seal lip by an easy configuration. Further, the deformation degree of the seal lip can be inspected even while the rotational member to which the sealing device is attached is rotating. Hereby, the deformation degree of the seal lip can be inspected without reducing operation efficiency.

The conductive member may be provided annularly along the circumferential direction of the seal lip so as to be concentric to the seal lip.

With the sealing device, the deformation of the seal lip is sensed over its entire circumference. As a result, it is possible to improve inspection accuracy of the deformation degree of the seal lip.

The conductive member may be an annular metal wire placed in the seal lip. A diameter of a section of the annular metal wire may be equal to or smaller than a predetermined diameter.

In a case where the conductive member is a bold metal wire, the deformation of the seal lip is disturbed by its rigidity. As a result, the deformation degree of the seal lip cannot be inspected accurately. In contrast, when the metal wire having a section with a diameter that is the predetermined diameter or less is used as the conductive member, a possibility to disturb deformation of the seal lip associated with wearing-out of the sealing surface is low because the rigidity of the metal wire is low. This makes it is possible to inspect the deformation degree with high accuracy.

The attachment portion may be provided with a core member, the core member having an L-shaped section with one side facing the seal lip. The detection unit may be placed on an inner surface of the core member.

When the detection unit is provided by effectively using a space in the sealing device as such, it is possible to restrain upsizing of the sealing device.

The detection unit may be configured to output a result detected by the detection unit.

Hereby, it is possible to easily find an inspection result.

The detection unit may be configured to output the result when the change of the inductance of the conductive member is larger than a predetermined threshold.

With the sealing device, when the predetermined threshold is set to a change value of the inductance at the time when the inductance decreases to around a value at which the seal performance of the sealing device is impaired, it is possible to easily find that the sealing device nears its use limit.

With the present disclosure, in terms of a sealing device including a seal lip having a sealing surface making close contact with a rotating shaft, it is possible to inspect a deformation degree of the seal lip caused due to wearing-out of the sealing surface without reducing operation efficiency of a rotational member.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a sectional view of a sealing device according to a first embodiment of the present disclosure;

FIG. 2 is a schematic view of an inductance circuit placed in a seal lip of the sealing device according to the first embodiment of the present disclosure, the inductance circuit including a conductive member;

FIG. 3 is a block diagram illustrating a functional configuration of a detection unit placed in the sealing device according to the first embodiment of the present disclosure;

FIG. 4 is a view to describe a principle to detect deformation of the seal lip in the first embodiment of the present disclosure;

FIG. 5 is a flowchart illustrating a flow of an operation of the sealing device to inspect the deformation of the seal lip in the first embodiment of the present disclosure;

FIG. 6 is a sectional view of a sealing device according to a second embodiment of the present disclosure;

FIG. 7 is a schematic view of an inductance circuit placed in a seal lip of the sealing device according to the second embodiment of the present disclosure, the inductance circuit including a conductive member; and

FIG. 8 is a view to describe a principle to detect deformation of the seal lip in the second embodiment of the present disclosure.

### DETAILED DESCRIPTION OF EMBODIMENTS

With reference to the drawings, the following describes embodiments of the present disclosure. In the following description, identical components or constituents have the same reference sign. They also have the same name and function. Accordingly, their detailed descriptions are not repeated herein.

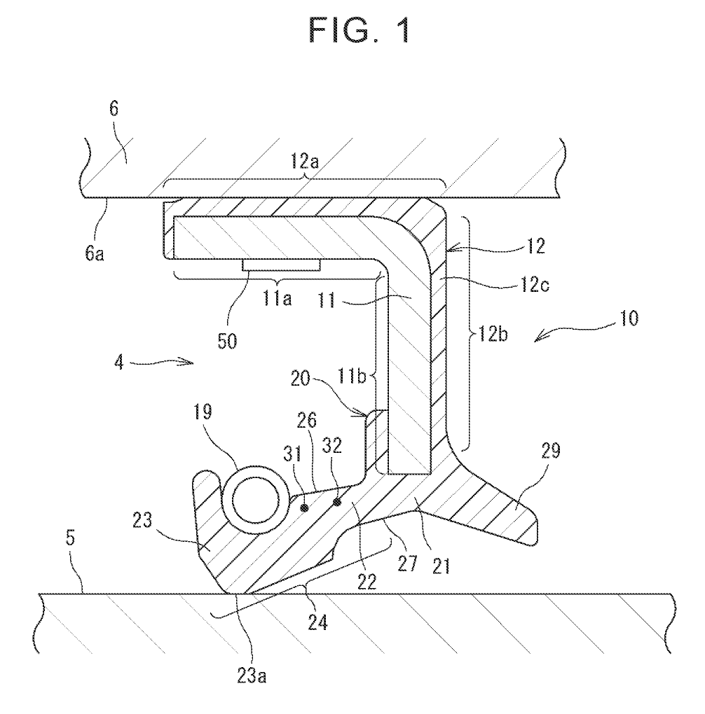

A sealing device 10 according to a first embodiment of the present disclosure is an oil seal as an example. FIG. 1 is a sectional view of the sealing device 10. The sealing device 10 is provided together with a rolling bearing (not shown) configured to support a shaft 5 with respect to a housing 6. The housing 6 has a cylindrical inner peripheral surface 6a. An annular space 4 is formed radially inward of the cylindrical inner peripheral surface 6a, between the housing 6 and the shaft 5. The rolling bearing is provided at a predetermined position in the annular space 4, and respective sealing devices 10 are provided on the opposite sides of the rolling bearing in an axial direction. The shaft 5 is a rotatable rotating shaft, for example. The housing 6 corresponds to an example of an “outer member” in the present disclosure.

The shaft 5 is made of a soft magnetic material. The soft magnetic material is iron, for example. The shaft 5 is assembled concentrically to the cylindrical inner peripheral surface 6a of the housing 6. The sealing device 10 has an annular shape and is attached to the annular space 4 so as to be concentric to the shaft 5.

The sealing device 10 includes an annular attachment portion 12 attached to the housing 6, and an annular seal body 20 integrated with the attachment portion 12. A sectional shape of the attachment portion 12 has an L-shape constituted by a cylindrical portion 12a making contact with the cylindrical inner peripheral surface 6a so as to extend in the axial direction of the shaft 5, and an annular portion 12b extending in a radial direction from the cylindrical inner peripheral surface 6a toward the shaft 5.

The seal body 20 includes a fixed portion 21 and a seal lip 24. The fixed portion 21 is a part fixed to an inner peripheral part of the annular portion 12b of the attachment portion 12. The seal lip 24 includes a lip head portion 23 and a lip base portion 22. The lip head portion 23 includes an annular sealing surface 23a formed in its inner periphery so as to make contact with the shaft 5. The lip base portion 22 is a part configured to connect the fixed portion 21 to the lip head portion 23.

The seal lip 24 extends from the fixed portion 21 as a base end toward a first side (the left side in FIG. 1) in the axial direction. The cylindrical portion 12a of the attachment portion 12 faces the seal lip 24 in the radial direction. An outer peripheral surface 26 and an inner peripheral surface 27 of the lip base portion 22 have a tapered shape reduced in diameter toward the lip head portion 23 side.

The seal body 20 may further include an auxiliary lip 29. The auxiliary lip 29 extends from the fixed portion 21 toward a second side in the axial direction.

The attachment portion 12 includes a rubber part 12c as an external surface, and an annular core member 11 with which the rubber part 12c is integrated by adhesion by vulcanization. The rubber part 12c is integrated with the seal body 20, and is made of rubber (elastomer), such as NBR, FKM, and ACM. The core member 11 is provided concentrically to the attachment portion 12. The core member 11 is made of metal, such as stainless steel. A sectional shape of the core member 11 also has an L-shape one side of which faces the seal lip 24, and is constituted by a cylindrical portion 11a extending in the axial direction of the shaft 5, and an annular portion 11b extending in the radial direction from the cylindrical inner peripheral surface 6a toward the shaft 5.

The sealing device 10 further includes an annular spring (garter spring) 19. The spring 19 tightens the lip head portion 23 to the shaft 5. The spring 19 is attached to an outer peripheral part of the lip head portion 23.

When the sealing device 10 is attached to the annular space 4, the sealing surface 23a of the lip head portion 23 makes contact with the shaft 5. When the shaft 5 rotates in a state where the sealing device 10 is attached to the annular space 4, the sealing surface 23a slides over the shaft 5. Hereby, sliding friction occurs on the sealing surface 23a.

When the sliding friction occurs on the sealing surface 23a, the sealing surface 23a is worn out. When the sealing surface 23a is worn out, the whole seal lip 24 deforms towards the shaft 5 side. Since the lip head portion 23 is tightened to the shaft 5 by the spring 19, the whole seal lip 24 easily deforms due to the wearing-out of the sealing surface 23a. When the seal lip 24 deforms by a predetermined amount or more, a contact pressure of the sealing surface 23a to the shaft 5 decreases, so that seal performance of the sealing device 10 is decreased.

In view of this, in order to prevent the decrease of the seal performance, the sealing device 10 has a function to inspect a deformation degree, i.e., whether or not the deformation of the seal lip 24 reaches the predetermined amount. As a constituent to implement the function to inspect the deformation degree of the seal lip 24, the sealing device 10 includes a first conductive member 31 functioning as a magnetic sensor, a second conductive member 32 as a sensing target for the first conductive member 31, and a detection unit 50. The first conductive member 31 corresponds to an example of a “conductive member” in the present disclosure. The second conductive member 32 corresponds to an example of a “reference member” in the present disclosure.

The first conductive member 31 is a metal member having conductivity, and preferably a linear or filament-shaped thin line (metal thin line) made of a metal material, such as copper. In the present embodiment, a metal thin line having a diameter of around 15 μm to 100 μm is used as the first conductive member 31. If a bold metal wire is used as the first conductive member 31, the deformation of the seal lip 24 is disturbed by its rigidity. As a result, the deformation degree of the seal lip 24 cannot be inspected accurately. In contrast, when a metal thin line is used as the first conductive member 31, it is possible to prevent the deformation of the seal lip 24 from being disturbed, because its rigidity is low. This makes it possible to improve inspection accuracy of the deformation degree of the seal lip 24.

The first conductive member 31 is integrated with the seal lip 24. To be integrated refers to a state where the first conductive member 31 is provided so as to behave (deform) along with the behavior (deformation) of the seal lip 24, and indicates a state where the first conductive member 31 is embedded in the seal lip 24, a state where the first conductive member 31 is attached on a surface of the seal lip 24, and the like state, for example. The first conductive member 31 is placed at a position where the first conductive member 31 does not make contact with the shaft 5 within the seal lip 24 or on the surface of the seal lip 24, for example. Preferably, the first conductive member 31 is placed at a position where the seal lip 24 largely deforms due to the wearing-out of the sealing surface 23a. As an example, the first conductive member 31 is placed near the spring 19 in the lip head portion 23. This makes it possible to inspect the deformation degree of the seal lip 24 with high accuracy.

The first conductive member 31 is an annular member and is provided in an annular shape along a circumferential direction of the seal lip 24 so as to be concentric to the seal lip 24. In the present embodiment, an annular metal thin line is embedded near the spring 19 so as to be concentric to the seal lip 24. Hereby, the deformation of the seal lip 24 is sensed over its entire circumference. This makes it possible to improve the inspection accuracy of the deformation degree of the seal lip 24.

In order that the first conductive member 31 functions as the magnetic sensor, a power source 60 (not shown in FIG. 1) is connected to the first conductive member 31, so that a voltage is applied thereto. In a case where the first conductive member 31 is a linear member, the power source 60 is an alternating-current power source and applies an alternating voltage to the first conductive member 31. In a case where the first conductive member 31 has a coil shape, the power source 60 is a direct-current power source and applies a direct voltage to the first conductive member 31. Hereby, an inductance circuit including the first conductive member 31 is formed.

The second conductive member 32 is also a metal member having conductivity, and preferably a metal thin line made of a metal material, such as copper. This makes it possible to prevent the deformation of the seal lip 24 due to the wearing-out of the sealing surface 23a from being disturbed, for the same reason as above. This makes it possible to improve the inspection accuracy of the deformation degree of the seal lip 24.

The second conductive member 32 is provided in the seal lip 24 or the attachment portion 12 in a state where the second conductive member 32 is distanced from the first conductive member 31 at a predetermined interval. As an example, the second conductive member 32 is placed within the seal lip 24 or on the surface of the seal lip 24. The second conductive member 32 is an annular member and is provided along the circumferential direction of the seal lip 24 so as to be concentric to the seal lip 24.

In the present embodiment, as illustrated in FIG. 1, the second conductive member 32 is embedded on a side closer to the fixed portion 21 than the position of the first conductive member 31, so as to be concentric to the seal lip 24. More specifically, in the present embodiment, the first conductive member 31 is placed near the spring 19 and the second conductive member 32 is placed on the side closer to the fixed portion 21 than the position of the first conductive member 31 so as to be distanced from the first conductive member 31. With such an arrangement, the first conductive member 31 deforms more largely than displacement of the second conductive member 32 at the time when the seal lip 24 deforms due to the wearing-out of the sealing surface 23a. This makes it possible to inspect the deformation degree of the seal lip 24 according to a detection principle that will be described later. Further, by placing the second conductive member 32 near the first conductive member 31, it is possible to improve the inspection accuracy of the deformation degree of the seal lip 24.

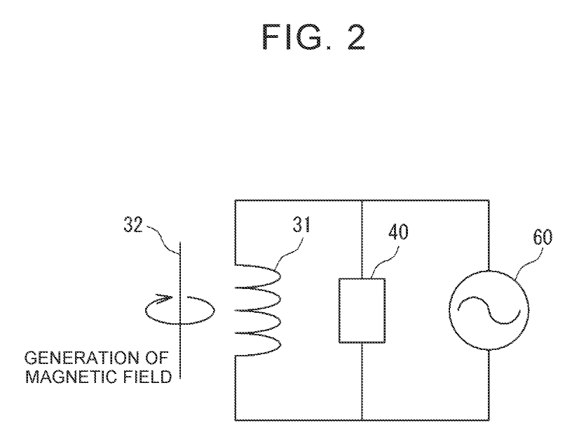

FIG. 2 is a schematic diagram of the inductance circuit including the first conductive member 31. With reference to FIG. 2, a measuring device 40 configured to measure an inductance is connected to the first conductive member 31. The measuring device 40 is an LCR meter, for example.

Preferably, the measuring device 40 and the power source 60 are placed in the sealing device 10. As an example, the measuring device 40 and the power source 60 are attached to an inner surface of the core member 11 having an L-shaped section. When the measuring device 40 and the power source 60 are provided by effectively using a space in the sealing device 10, it is possible to restrain upsizing of the sealing device 10.

The detection unit 50 includes one or more central processing units (CPU) and memories (both not shown). When the CPU executes a program stored in the memory, the detection unit 50 executes a process of detecting deformation of the seal lip 24.

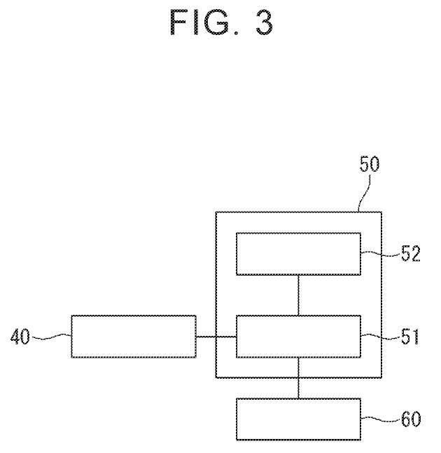

FIG. 3 is a block diagram indicative of a functional configuration of the detection unit 50. With reference to FIG. 3, the detection unit 50 is connected to the measuring device 40 via a signal wire (not shown), so as to receive a measured value of the inductance from the measuring device 40. The detection unit 50 includes a detection control portion 51 configured to execute the process of detecting the deformation of the seal lip 24 by using the measured value of the inductance, and an output control portion 52 configured to control an output based on a detected result. The functions are implemented mainly by the CPU (not shown) of the detection unit 50 such that the CPU executes programs stored in the memory.

The power source 60 may be further connected to the detection unit 50 so as to supply electric power to the detection unit 50. Furthermore, the power source 60 may supply electric power to the first conductive member 31 via the detection unit 50. At this time, the detection unit 50 may further include an electric power controlling portion configured to control power supply from the power source 60 to the first conductive member 31. Electric power may be supplied to the detection unit 50 from a power source different from the power source 60.

Preferably, the detection unit 50 is placed in the sealing device 10. More specifically, the detection unit 50 is attached to a surface of the sealing device 10. More preferably, the detection unit 50 is attached to the inner surface of the core member 11 having an L-shaped section. The inner surface of the core member 11 is a side surface facing the seal lip 24. More specifically, the inner surface of the core member 11 is a surface of the cylindrical portion 11a facing the seal lip 24, or a surface of the annular portion 11b on a side where the seal lip 24 extends. When the detection unit 50 is provided by effectively utilizing the space of the sealing device 10, it is possible to restrain upsizing of the sealing device 10. In the present embodiment, the detection unit 50 is attached to the surface of the cylindrical portion 11a facing the seal lip 24.

The detection unit 50 may be placed outside the sealing device 10. In this case, the detection unit 50 preferably communicates wirelessly with the measuring device 40. Note that the configuration in which the detection unit 50 is placed outside the sealing device 10 and communicates wirelessly with the measuring device 40 is also included in a state where the detection unit 50 is provided in the sealing device 10.

Preferably, the measuring device 40 and the power source 60 are placed near the detection unit 50. The measuring device 40 and the power source 60 may be included in the detection unit 50. Hereby, the measuring device 40 and the power source 60 are easily connected to the first conductive member 31 forming the inductance circuit in FIG. 2, and are also easily connected to the detection unit 50.

Further, the power source 60 may have a power generation function. This makes it possible to eliminate the need for power supply to the detection unit 50 and the first conductive member 31 from outside. Note that the power source 60 may be placed outside the sealing device 10 so as to supply electric power to the detection unit 50 and the first conductive member 31 via a power line (not shown) or wireless communication.

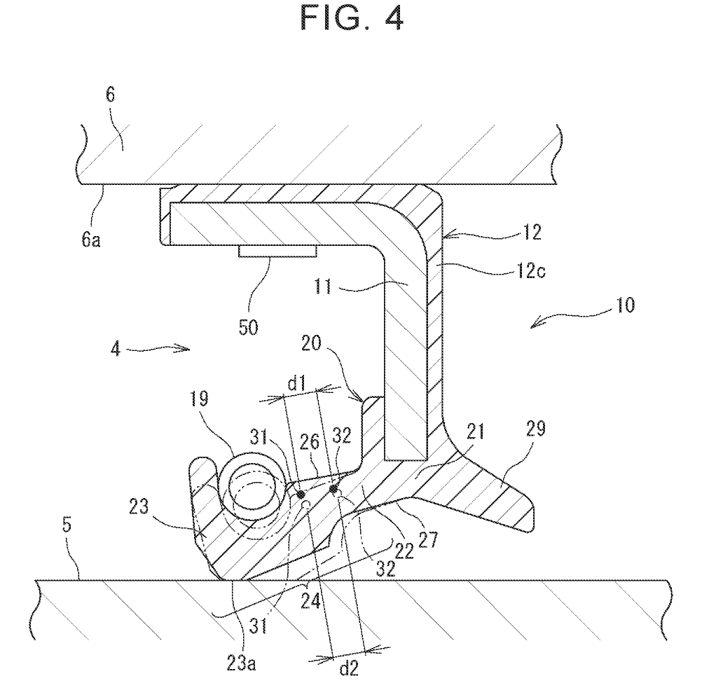

FIG. 4 is a view to describe a principle to detect deformation of the seal lip 24. In FIG. 4, the seal lip 24 is indicated by a continuous line and an alternate long and two short dashes line. The seal lip 24 in the continuous line indicates a state before the sealing surface 23a is worn out. The seal lip 24 in the alternate long and two short dashes line indicates a state where the sealing surface 23a has been worn out.

With reference to FIG. 4, when the sealing surface 23a is worn out, the seal lip 24 deforms toward the shaft 5 side, starting from the fixed portion 21. Due to the deformation of the seal lip 24, an interval between the first conductive member 31 and the second conductive member 32 changes from an interval d1 to an interval d2.

Since a voltage is applied to the first conductive member 31, a magnetic field is generated around the first conductive member 31. When the interval (distance) between the first conductive member 31 and the second conductive member 32 changes, magnetic resistance around the first conductive member 31 changes. Hereby, the inductance of the first conductive member 31 changes. That is, a change of the interval between the first conductive member 31 and the second conductive member 32 can be detected as a change of the inductance of the first conductive member 31.

An initial value of the inductance of the first conductive member 31 before the sealing surface 23a is worn out is stored in the detection control portion 51. The initial value may be a measured value of the inductance of the first conductive member 31 just after the first conductive member 31 is attached to the sealing device 10. Alternatively, a set initial value may be stored in the detection control portion 51 in advance. The detection control portion 51 obtains a change amount in measured value by calculating a difference between the initial value and a measurement result by the measuring device 40.

A magnitude of the change of the inductance of the first conductive member 31 depends on a change amount |d1−d2| of the interval between the first conductive member 31 and the second conductive member 32. That is, when the change amount |d1−d2| is large, the change amount of the inductance of the first conductive member 31 is large. In view of this, the detection control portion 51 is configured such that a change value of the inductance at the time when the inductance decreases to around a value at which the seal performance of the sealing device 10 is impaired is stored in the detection control portion 51 in advance as a threshold, so that the detection control portion 51 determines whether or not a change amount of a measured value, that is, a change of the inductance of the first conductive member 31 exceeds the threshold. A case where the change of the inductance exceeds the threshold indicates a state just before the seal performance of the sealing device 10 is impaired, that is, a state where the sealing device 10 almost reaches its use limit. The threshold is found in advance by experiment.

The detection control portion 51 inputs a determination result into the output control portion 52. The output control portion 52 is connected to an output device (not shown). The output control portion 52 outputs an inspection result based on the determination result from the output device. Hereby, it is possible to easily find an inspection result of the deformation degree of the seal lip 24.

Preferably, the output control portion 52 outputs the inspection result based on the determination result when the change of the inductance is larger than the threshold. The output device is a radio transmitter or an audio output device (a speaker), for example. Hereby, it is possible to easily find that the inspection result indicates that the seal lip 24 has deformed to such a degree that the seal performance of the sealing device 10 is impaired, that is, the sealing device 10 has reached its use limit.

Note that the first conductive member 31 and the second conductive member 32 are placed in the seal lip 24, so that an interval therebetween is small. Particularly, when the first conductive member 31 and the second conductive member 32 are embedded in the seal lip 24 as illustrated in FIG. 1, the interval therebetween is very small. On that account, the change amount |d1−d2| of the interval due to the deformation of the seal lip 24 is also very small. As a result, the change of the inductance is also very small. Because of this, it might be difficult to inspect the deformation degree of the seal lip 24 based on the change of the inductance, in some cases.

In view of this, preferably, the sealing device 10 is configured such that a voltage is also applied to the second conductive member 32, so as to generate a magnetic field around the second conductive member 32. On that account, the second conductive member 32 is also connected to a power source (not shown). As the power source, the power source 60 for the first conductive member 31 may be used in common. When the second conductive member 32 is a metal wire, an alternating-current power source is connected to the second conductive member 32, so as to apply an alternating voltage thereto.

By generating the magnetic field around the second conductive member 32, it is possible to increase an influence on the magnetic field around the first conductive member 31 as compared with a case where the magnetic field is not generated around the second conductive member 32. That is, by generating the magnetic field around the second conductive member 32, it is possible to more largely change magnetic resistance around the first conductive member 31 at the time when the interval between the first conductive member 31 and the second conductive member 32 changes. As a result, the change of the interval between the first conductive member 31 and the second conductive member 32, that is, the deformation degree of the seal lip 24 can be inspected with higher accuracy.

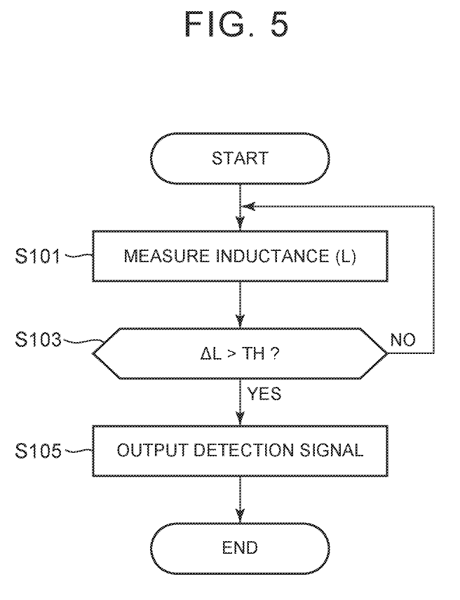

FIG. 5 is a flowchart illustrating a flow of an operation of the sealing device 10 to inspect the deformation degree of the seal lip 24. The flowchart of FIG. 5 indicates an inspection method for inspecting the deformation degree of the seal lip 24 in the sealing device 10.

With reference to FIG. 5, in the sealing device 10, an inductance L of the first conductive member 31 is measured by the measuring device 40 at a predetermined timing (step S101). The predetermined timing is, for example, a timing determined in advance (e.g., a rotation start timing, a timing after a predetermined time elapses from the rotation start, and the like), a predetermined interval, and the like.

The detection control portion 51 calculates a change ΔL from an initial value of the inductance L and compares it with the threshold TH. When the change ΔL of the inductance is larger than the threshold TH (YES in step S103), the detection control portion 51 outputs a detection signal to the output control portion 52 (step S105). The output control portion 52 outputs a determination result in the detection control portion 51 using an output device (not shown) such as a radio transmitter.

Thus, the sealing device 10 according to the first embodiment of the present disclosure is configured such that: the sealing device 10 employs the first conductive member and the second conductive member provided in the seal lip 24 or the attachment portion 12 so as to be distanced from each other at a predetermined interval; and the sealing device 10 uses one of the first conductive member and the second conductive member as a magnetic sensor, so as to inspect the deformation degree of the seal lip 24 as a change of an interval between the first conductive member and the second conductive member based on a change of an inductance. Accordingly, it is possible to inspect the deformation degree of the seal lip 24 with high accuracy by a simple configuration. Further, even during rotation of the rolling bearing, it is possible to inspect the deformation degree of the seal lip 24. Hereby, the deformation degree of the seal lip 24 can be inspected without reducing operation efficiency of the rolling bearing.

By setting the threshold to an appropriate value, it is possible to find a timing to replace the seal lip 24 before the seal performance of the sealing device 10 is impaired. As a result, the sealing device 10 can be replaced before the seal performance of the sealing device 10 is impaired to cause an invasion of a foreign matter into the annular space or an outflow of the lubricant to outside the annular space. Further, by setting the threshold to an appropriate value, a replacement cycle of the sealing device can be set to an appropriate cycle according to a degree of the wearing-out of the sealing surface 23a.

Note that a magnitude of the change of the inductance of the first conductive member 31 depends on not only the change amount |d1−d2| of the interval between the first conductive member 31 and the second conductive member 32, but also a change amount of an interval between the first conductive member 31 and the shaft 5. The following describes a second embodiment of the present disclosure. In the second embodiment, the same constituent as in the first embodiment has the same reference sign as in the first embodiment, and a description thereof is omitted.

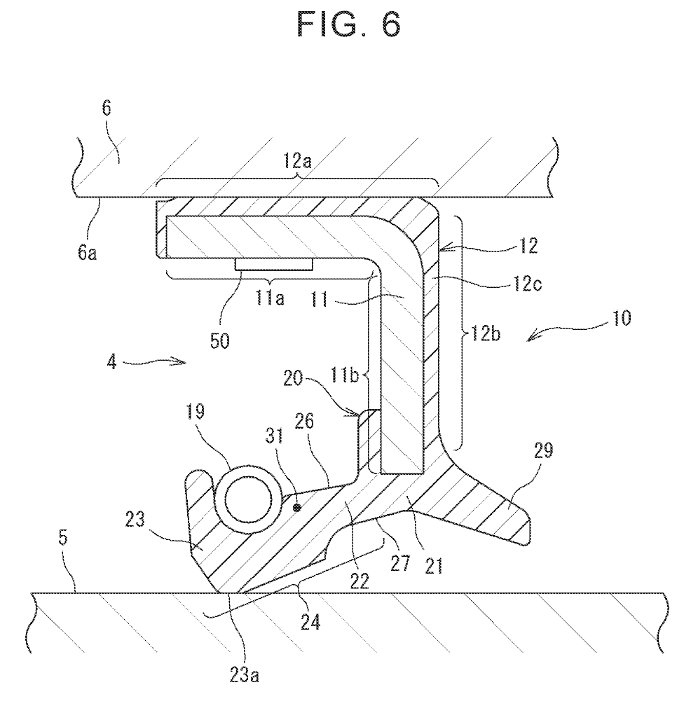

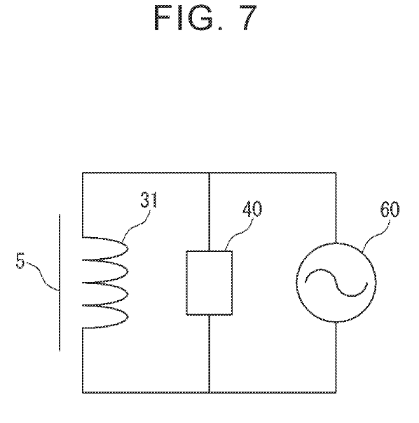

A sealing device 10 according to the second embodiment of the present disclosure is an oil seal, for example. FIG. 6 is a sectional view of the sealing device 10. Differently from the first embodiment of the present disclosure, the sealing device 10 according to the second embodiment of the present disclosure does not include the second conductive member 32. On this account, in FIG. 7 that is a schematic view of an inductance circuit according to the second embodiment of the present disclosure, the second conductive member 32 is not illustrated. Further, the configuration of the detection unit 50 of the second embodiment of the present disclosure is the same as the configuration of the detection unit 50 of the first embodiment of the present disclosure as illustrated in FIG. 3.

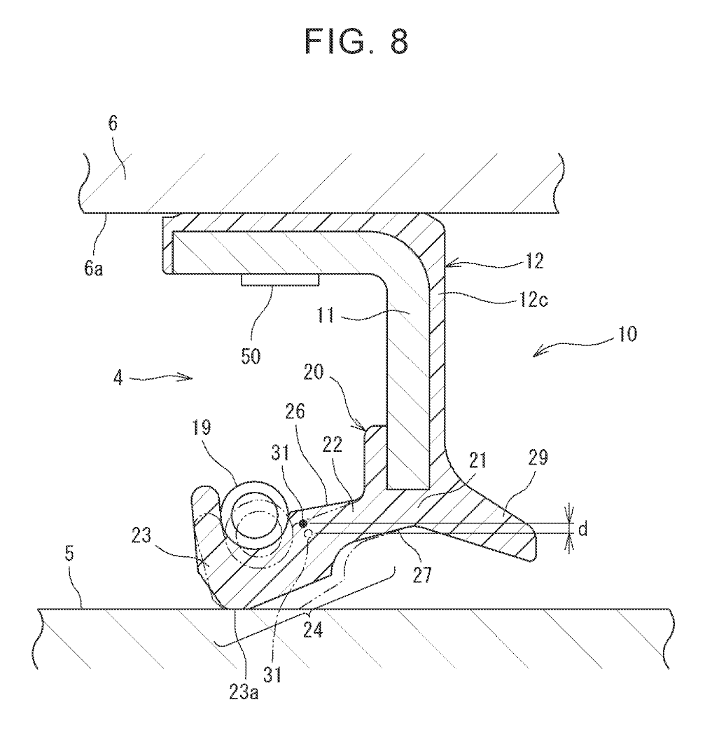

FIG. 8 is a view to describe a principle to detect deformation of the seal lip 24 of the second embodiment of the present disclosure. In FIG. 8, the seal lip 24 is indicated by a continuous line and an alternate long and two short dashes line. The seal lip 24 in the continuous line indicates a state before the sealing surface 23a is worn out. The seal lip 24 in the alternate long and two short dashes line indicates a state where the sealing surface 23a has been worn out.

Referring to FIG. 8, when the sealing surface 23a is worn out, the seal lip 24 deforms toward the shaft 5 side, starting from the fixed portion 21. Due to the deformation of the seal lip 24, the interval between the first conductive member 31 and the shaft 5 is decreased by a distance d.

Since a voltage is applied to the first conductive member 31, a magnetic field is generated around the first conductive member 31. When the interval (distance) between the first conductive member 31 and the shaft 5 changes, magnetic resistance around the first conductive member 31 changes. Hereby, an inductance of the first conductive member 31 changes. That is, a change of the interval between the first conductive member 31 and the shaft 5 can be detected as a change of the inductance of the first conductive member 31. Here, the shaft 5 corresponds to an example of a “reference member” in the present disclosure.

An initial value of the inductance of the first conductive member 31 before the sealing surface 23a is worn out is stored in the detection control portion 51. The initial value may be a measured value of the inductance of the first conductive member 31 just after the first conductive member 31 is attached to the sealing device 10. Alternatively, a set initial value may be stored in the detection control portion 51 in advance. The detection control portion 51 obtains a change amount of the measured value by calculating a difference between the initial value and a measurement result by the measuring device 40.

A magnitude of the change of the inductance of the first conductive member 31 depends on a change amount d of the interval between the first conductive member 31 and the shaft 5. That is, when the change amount d is large, the change amount of the inductance of the first conductive member 31 is large. In view of this, the detection control portion 51 is configured such that a change value of the inductance at the time when the inductance decreases to around a value at which the seal performance of the sealing device 10 is impaired is stored therein in advance as a threshold, so that the detection control portion 51 determines whether or not a change amount of a measured value, that is, a change of the inductance of the first conductive member 31 exceeds the threshold. A case where the change of the inductance exceeds the threshold indicates a state just before the seal performance of the sealing device 10 is impaired, that is, a state where the sealing device 10 almost reaches its use limit. The threshold is found in advance by experiment.

Particularly, since the shaft 5 is a soft magnetic material, a magnetic field is generated around the shaft 5 by rotating. On this account, when the interval between the first conductive member 31 and the shaft 5 changes due to the deformation of the seal lip 24, magnetic resistance around the first conductive member 31 more largely changes. As a result, the change of the interval between the first conductive member 31 and the shaft 5, that is, the deformation degree of the seal lip 24 can be inspected with higher accuracy.

The detection control portion 51 inputs a determination result into the output control portion 52. The output control portion 52 is connected to an output device (not shown). The output control portion 52 outputs an inspection result based on the determination result from the output device. Hereby, it is possible to easily find the inspection result of the deformation degree of the seal lip 24. Further, in the second embodiment, the operation of the sealing device 10 to inspect the deformation degree of the seal lip 24 is the same as the operation of the sealing device 10 according to the first embodiment as illustrated in FIG. 5.

Thus, the sealing device 10 according to the second embodiment of the present disclosure is configured such that: by using the first conductive member 31 provided in the seal lip 24 as a magnetic sensor, the sealing device 10 inspects the deformation degree of the seal lip 24 as a change of the interval between the first conductive member and the shaft 5 based on a change of the inductance. Accordingly, it is possible to inspect the deformation degree of the seal lip 24 with high accuracy by a simple configuration. Further, even during rotation of the rolling bearing, it is possible to inspect the deformation degree of the seal lip 24. Hereby, the deformation degree of the seal lip 24 can be inspected without reducing operation efficiency of the rolling bearing.

In the first embodiment of the present disclosure, the first conductive member 31 and the second conductive member 32 are annular members. However, either one of the conductive members or both conductive members may include a plurality of arcuate members and may be configured such that the arcuate members are arranged at predetermined intervals along the circumference of a circle. Further, in the second embodiment of the present disclosure, the first conductive member 31 is an annular member, but the first conductive member 31 may be configured such that several arcuate members are arranged at predetermined intervals along the circumference of a circle.

In the first embodiment of the present disclosure, the first conductive member 31 functioning as a magnetic sensor and the second conductive member 32 as a sensing target thereof are prepared as special members for inspecting the change of the inductance, and are placed in the sealing device 10. The first conductive member 31 and the second conductive member 32 can be hereby placed at respective optimum positions. However, as another example, a member having conductivity and constituting the sealing device 10 may also be used as at least one conductive member out of the first conductive member 31 and the second conductive member 32.

The member having conductivity and constituting the sealing device 10 is the core member 11, for example. As an example, a sealing device 10 according to a modification takes the core member 11 as the second conductive member 32, and detects a change of an interval between the first conductive member 31 and the core member 11 associated with deformation of the seal lip 24, as a change of the inductance of the first conductive member 31. In order that the core member 11 functions as the second conductive member 32, a power source is connected to the core member 11, so as to apply an alternating voltage thereto. Hereby, a magnetic field is generated around the core member 11, so that a change of the interval between the first conductive member 31 and the core member 11 can be detected as a change of the inductance of the first conductive member 31 with high accuracy.

As another example, the core member 11 is provided as the first conductive member 31, so that a change of an interval between the core member 11 and the second conductive member 32 associated with deformation of the seal lip 24 is detected as a change of an inductance of the core member 11. In order that the core member 11 functions as the first conductive member 31, the power source 60 is connected to the core member 11 so as to apply an alternating voltage thereto, and the measuring device 40 is connected thereto so as to measure the inductance. Hereby, a magnetic field is generated around the core member 11, so that a change of the interval between the core member 11 and the second conductive member 32 can be detected as a change of the inductance of the core member 11 with high accuracy.

Another example of the member having conductivity and constituting the sealing device 10 is the spring 19. As an example, a sealing device 10 according to another modification takes the spring 19 as the second conductive member 32, and detects a change of an interval between the first conductive member 31 and the spring 19 associated with deformation of the seal lip 24, as a change of the inductance of the first conductive member 31. In order that the spring 19 functions as the second conductive member 32, a power source is connected to the spring 19 so as to apply a voltage thereto. Since the spring 19 has a coil shape, a direct voltage is applied thereto. Hereby, a magnetic field is generated around the spring 19, so that a change of the interval between the first conductive member 31 and the spring 19 can be detected as a change of the inductance of the first conductive member 31 with high accuracy.

As another example, the spring 19 is taken as the first conductive member 31, so that a change of an interval between the spring 19 and the second conductive member 32 associated with deformation of the seal lip 24 is detected as a change of an inductance of the spring 19. In order that the spring 19 functions as the first conductive member 31, the power source 60 is connected to the spring 19 so as to apply a voltage to the spring 19, and the measuring device 40 is connected to the spring 19 so as to measure the inductance. Since the spring 19 has a coil shape, a direct voltage is applied thereto. Hereby, a magnetic field is generated around the spring 19, so that a change of the interval between the spring 19 and the second conductive member 32 can be detected as a change of the inductance of the spring 19.

Further, as another example, one of the core member 11 and the spring 19 may be taken as the first conductive member 31 and the other one thereof may be taken as the second conductive member 32, so that a change of an interval between the core member 11 and the spring 19 associated with deformation of the seal lip 24 may be detected as a change of an inductance of the core member 11 or the spring 19.

When the member having conductivity and constituting the sealing device 10 is used as at least one conductive member out of the first conductive member 31 and the second conductive member 32, the number of components to be placed in the sealing device 10 can be restrained. This makes it possible to easily manufacture the sealing device 10 and to achieve weight reduction of the sealing device 10.

Note that, in the above description, the sealing device 10 is an oil seal, for example. However, the sealing device 10 may be any sealing device, provided that the sealing device includes a seal lip making close contact with the rotating shaft of the rotational member.

It should be considered that the embodiments described herein are just examples in all respects and are not limitative. The scope of the present disclosure is shown by claims, not by the descriptions, and intended to include all modifications made within the meaning and scope equivalent to the claims.

What is claimed is:

1. A sealing device provided radially inward of an inner peripheral surface of an outer member, the sealing device comprising:
an attachment portion having an annular shape and attached to the outer member;
a seal lip having an annular shape, the seal lip being fixed to the attachment portion and having a sealing surface in an inner peripheral part of the seal lip, the sealing surface making contact with a shaft provided radially inward of the inner peripheral surface of the outer member;
a conductive member integrated with the seal lip along a circumferential direction of the seal lip, the conductive member being configured such that a voltage is applied to the conductive member;
a reference member placed so that a predetermined interval is provided between the conductive member and the reference member; and
a detection unit, wherein the detection unit detects a change of an inductance of the conductive member associated with a change of the interval between the conductive member and the reference member.

2. The sealing device according to claim 1, wherein the reference member is a member having conductivity and provided in the seal lip or the attachment portion in a state where the member is distanced from the conductive member at the predetermined interval.

3. The sealing device according to claim 2, wherein the conductive member is provided annularly along the circumferential direction of the seal lip so as to be concentric to the seal lip.

4. The sealing device according to claim 2, wherein the reference member is provided annularly along the circumferential direction of the seal lip so as to be concentric to the seal lip.

5. The sealing device according to claim 2, wherein:
the conductive member and the reference member are annular metal wires placed in the seal lip; and
a diameter of section of each of the annular metal wires is equal to or smaller than a predetermined diameter.

6. The sealing device according to claim 2, wherein the reference member is a core member provided in the attachment portion.

7. The sealing device according to claim 6, wherein:
the core member has an L-shaped section with one side facing the seal lip; and
the detection unit is placed on an inner surface of the core member.

8. The sealing device according to claim 2, wherein the reference member is an annular spring configured to tighten an inner periphery of the seal lip to the shaft.

9. The sealing device according to claim 2, wherein a voltage is applied to the reference member.

10. The sealing device according to claim 1, wherein the reference member is the shaft.

11. The sealing device according to claim 10, wherein the conductive member is provided annularly along the circumferential direction of the seal lip so as to be concentric to the seal lip.

12. The sealing device according to claim 10, wherein:
the conductive member is an annular metal wire placed in the seal lip; and
a diameter of a section of the annular metal wire is equal to or smaller than a predetermined diameter.

13. The sealing device according to claim 10, wherein:
the attachment portion is provided with a core member, the core member having an L-shaped section with one side facing the seal lip; and
the detection unit is placed on an inner surface of the core member.

14. The sealing device according to claim 1, wherein the detection unit is configured to output a result detected by the detection unit.

15. The sealing device according to claim 14, wherein the detection unit is configured to output the result when the change of the inductance of the conductive member is larger than a predetermined threshold.
